(19) United States
(12) Patent Application Publication
(10) Pub. No.: US 2011/0062920 A1
(43) Pub. Date: Mar. 17, 2011

(54) POWER SUPPLY, TEST APPARATUS, AND CONTROL METHOD

(75) Inventor: Masahiro NAGATA, Gunma (JP)

(73) Assignee: ADVANTEST CORPORATION, Tokyo (JP)

(21) Appl. No.: 12/849,748

(22) Filed: Aug. 3, 2010

(30) Foreign Application Priority Data
Aug. 18, 2009 (JP) 2009-189487

(51) Int. Cl. G05F 1/10

(52) U.S. Cl. 323/271

(57) ABSTRACT

A power supply that outputs an output voltage corresponding to a specified voltage through an output terminal includes a plurality of switches that selects which of a high voltage and a low voltage is coupled to the output terminal, a multi-phase pulse width modulating section that controls a pulse width of the high voltage output from each of the plurality of the switches to cause the output voltage to approach the specified voltage, and a changing section that changes a voltage difference between the high voltage and the low voltage according to the specified voltage or the output voltage.

### BACKGROUND

1. Technical Field

The present invention relates to a power supply, a test apparatus and a control method.

2. Related Art

A power amplifier and a power supply that include a switching element performing switching operations and a power supply device supplying electric power to the switching element, and output a constant voltage by controlling timings of switching have been known.

Japanese Patent Application Publication 2006-217109 (Patent Document 1), Japanese Patent Application Publication H.11-97940 (Patent Document 2) and Japanese Patent Application Publication 2002-94340 (Patent Document 3) are examples of the related art.

In circuits that conduct switching control, output noise depends on ripple current. For this reason, it is preferable that fluctuations in the ripple current be eliminated in order to reduce the output noise.

### SUMMARY

Therefore, it is an object of an aspect of the innovations herein to provide a power supply, a test apparatus and a control method, which are capable of overcoming the above drawbacks accompanying the related art. The above and other objects can be achieved by combinations described in the claims. Moreover, dependent claims specify advantageous and exemplary combinations of the innovations herein.

An aspect of the innovations may include a power supply that outputs an output voltage corresponding to a specified voltage through an output terminal and includes a plurality of switches that selects which of a high voltage and a low voltage is coupled to the output terminal, a multi-phase pulse width modulating section that controls a pulse width of the high voltage output from each of the plurality of the switches to cause the output voltage to approach the specified voltage, and a changing section that changes a voltage difference between the high voltage and the low voltage according to the specified voltage or the output voltage.

The summary clause does not necessarily describe all necessary features of the embodiments of the present invention. The present invention may also be a sub-combination of the features described above. The above and other features and advantages of the present invention will become more apparent from the following description of the embodiments taken in conjunction with the accompanying drawings.

### BRIEF DESCRIPTION OF THE DRAWINGS

FIG. 1 shows a configuration of a test apparatus 100 according to an embodiment of the invention together with a device under test 10.

FIG. 2 illustrates changes in currents output at each point in the power supply section 110 of the test apparatus 100 according to the embodiment.

FIG. 3 illustrates an operation flow of the test apparatus 100 according to the embodiment.

### DESCRIPTION OF EXEMPLARY EMBODIMENT

Hereinafter, an embodiment of the present invention will be described. The embodiment does not limit the invention according to the claims, and all the combinations of the features described in the embodiments are not necessarily essential to means provided by aspects of the invention.

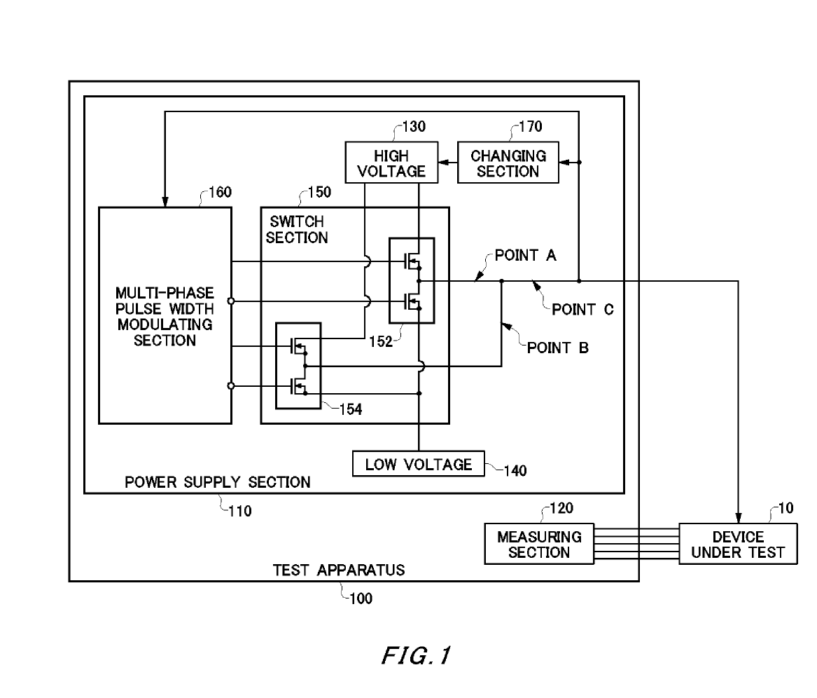

FIG. 1 shows a configuration of a test apparatus 100 according to an embodiment of the invention together with a device under test 10. The test apparatus 100 tests the device under test 10. An example of the device under test 10 includes analog circuits, digital circuits, memories and system-on-chips (SOCs). The test apparatus 100 supplies the device under test 10 with a test signal generated based on a test pattern for testing the device under test 10, and determines whether the device under test 10 is acceptable based on an output signal output by the device under test 10 in accordance with the test signal. The test apparatus 100 also adjusts a bias voltage in accordance with a specified voltage or an output voltage to reduce fluctuation in a ripple current. The test apparatus 100 includes a power supply section 110 and a measuring section 120.

The power supply section 110 is a power supply that outputs an output voltage corresponding to a specified voltage through an output terminal to supply power to the device under test 10. The power supply section 110 may provide power through a low-pass filter that removes noise, ripples and so forth. The power supply section 110 has a high voltage 130, a low voltage 140, a switch section 150, a multi-phase pulse width modulating section 160 and a changing section 170.

The high voltage 130 and the low voltage 140 may include a constant-voltage source capable of changing an output voltage, and the constant-voltage source may output a predetermined voltage in response to an external control signal. The test apparatus 100 provides the switch section 150 with an intended potential difference using the high voltage 130 and the low voltage 140.

The switch section 150 may include a plurality of switches, and a portion of the switch section 150 may include at least a pair of switches. The switch section 150 may also include at least a set of switch pairs. For the example shown in FIG. 1, the switch section 150 includes a first switch 152 and a second switch 154.

The first switch 152 and the second switch 154 respectively select the high voltage 130 or the low voltage 140 to be coupled to the output terminal. Each of the plurality of the switches may be a switch capable of switching an electric signal, for example, it includes one or more semiconductor device such as a transistor and/or a field effect transistor (FET). The first switch 152 and the second switch 154 are respectively switched with control signals from the multi-phase pulse width modulating section 160.

The multi-phase pulse width modulating section 160 controls a pulse width of a high voltage output from each of the plurality of the switches in the switch section 150 to make an output voltage close to a specified voltage. The multi-phase pulse width modulating section 160 produces a plurality of pulse wave patterns with variable pulse widths and variable pulse phases. The multi-phase pulse width modulating section 160 may flexibly generate wave patterns having an intended pulse width, pulse phase and amplitude by using a digital control circuit.

The multi-phase pulse width modulating section 160 may modulate the high voltages 130 output from at least a set of switch pairs among the plurality of the switches in the switch section 150, for example, the high voltages output from two pairs of switches have inverted phases each other. Moreover, in the example shown in FIG. 1, the multi-phase pulse width modulating section 160 may supply the first switch 152 with a pulse wave pattern for outputting the high voltage 130 therefrom, and at the same time may supply the second switch 154 with a pulse wave pattern for outputting the low voltage 140 therefrom. Alternatively, the multi-phase pulse width modulating section 160 may supply the first switch 152 with a pulse wave pattern for outputting the low voltage 140 therefrom, and at the same time may supply the second switch 154 with a pulse wave pattern for outputting the high voltage 130 therefrom.

The changing section 170 changes a voltage difference between the high voltage 130 and the low voltage 140 according to a specified voltage or an output voltage. The changing section 170 may change the voltage difference between the high voltage 130 and the low voltage 140 such that the specified voltage or the output voltage are set to an intermediate voltage between the high voltage 130 and the low voltage 140. Here, outputs of the plurality of the switches in the switch section 150 are connected to generate one signal, and the signal is output as the output voltage. The changing section 170 may also change the voltage difference between the high voltage 130 and the low voltage 140 such that a duty of a pulse width of a signal output by the multi-phase pulse width modulating section 160 approaches to a prescribed value.

The measuring section 120 sends, to the device under test 10, a test signal that corresponds to a test pattern for testing the device under test 10, and receives an output signal output by the device under test 10 in response to the test signal. The measuring section 120 may determine whether the device under test 10 is acceptable by comparing the received signal to an expected value. The measuring section 120 may be coupled to more than one device under test 10 and may test them.

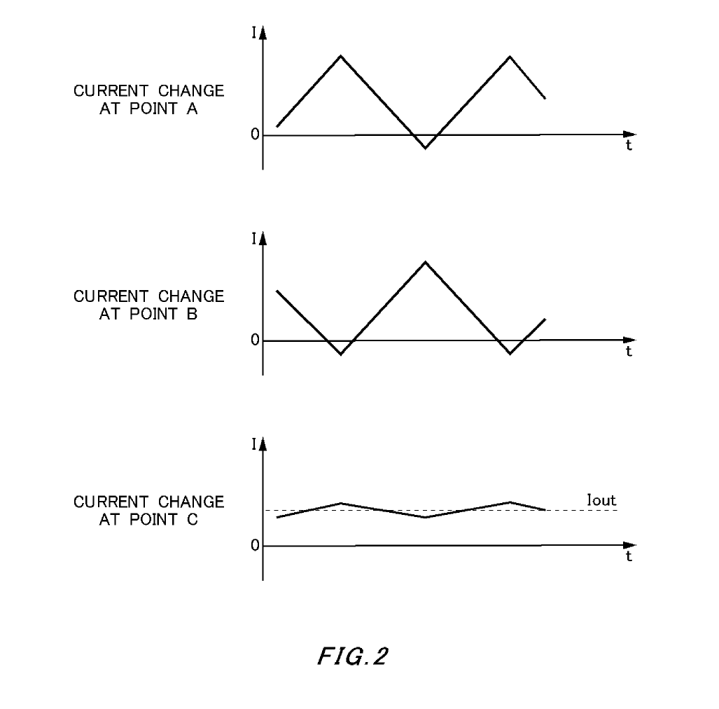

FIG. 2 illustrates changes in output currents at each point in the power supply section 110 of the test apparatus 100 according to the embodiment. An output of the first switch 152 can be measured at a point A shown in FIG. 1. When the high voltage 130 and the low voltage 140 are alternatively switched by output pulses of the multi-phase pulse width modulating section 160, a resulted current change at the point A is, for example, shown in FIG. 2. In the example shown here, the power supply section 110 supplies a positive voltage. Although the example of the change in the current illustrated in FIG. 2 has a triangular waveform, the waveform can be different depending on timing and a period in which the first switch 152 is switched, the potential difference between the high voltage 130 and the low voltage 140 and so forth.

The multi-phase pulse width modulating section 160 inverts a phase of the output of the second switch 154 with respect to the first switch 152, so that a change in current at a point B, which is an output of the second switch 154, also has a pattern of which phase is inverted with respect to the phase of the current pattern of the point A. A current change at a point C is essentially same as a sum of current change patterns at the point A and the point B, and becomes a constant voltage after removing noise such as ripples.

It can be easily appreciated that the current change at the point C remains also substantially constant even when the power supply section 110 outputs a negative voltage because the current changes at the points are only translated along the current axis respectively. Moreover, even when the switch section 150 includes more than two switches, the current change at the point C is substantially constant as long as the switches work as a set of switch pairs each of which has inverted output phase each other.

The power supply section 110 may use a filter to remove a ripple component, noise and so forth which cannot be canceled by summing the outputs of the switches. The power supply section 110 outputs a constant voltage on which a remaining component is superposed as noise. In order to reduce the noise component, the power supply section 110 adjusts the high voltage 130 such that a pulse pattern output by the multi-phase pulse width modulating section 160 has a duty cycle which can prevent ripple currents. For example, when the plurality of the switches includes at least a set of the switch pairs, it is possible to reduce the ripple current by outputting a wave pattern having a duty cycle of 50%, so that the power supply section 110 may adjust the high voltage 130 so as to have the duty cycle of 50%.

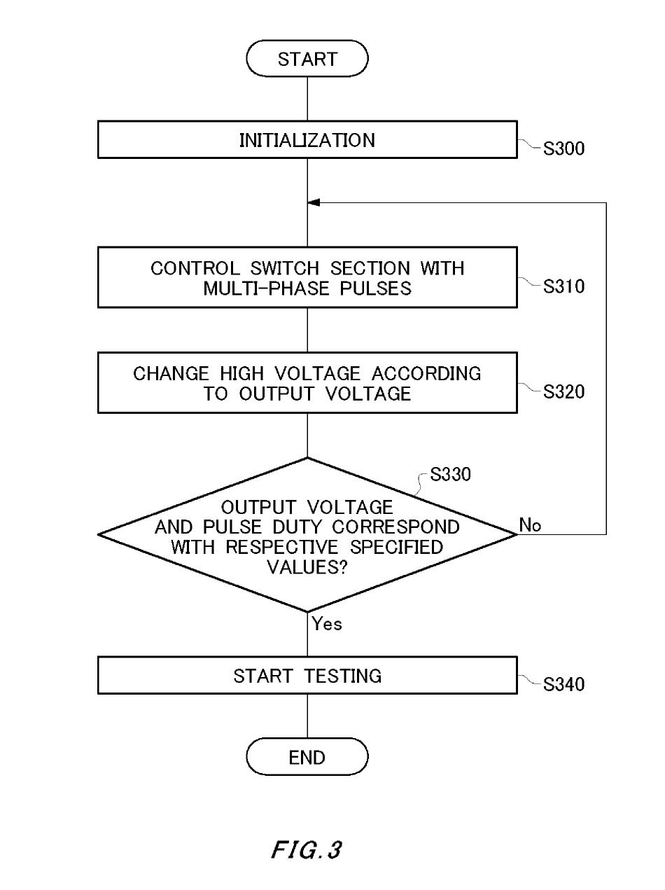

FIG. 3 illustrates an operation flow of the test apparatus 100 according to the embodiment. The test apparatus 100 conducts initialization of a test according to a specification prescribed by a user. The test apparatus 100 may set a specified voltage of the power supply section 110 in addition to parameters used for the test as the setting terms. Here, the test apparatus 100 may set an allowable range of an error between the specified voltage and an output voltage.

The test apparatus 100 may also set initial values of parameters for pulses output by the multi-phase pulse width modulating section 160 and initial values of the high voltage 130 and the low voltage 140 as the setting terms. The test apparatus 100 may also set a specified value for a duty cycle of a pulse output by the multi-phase pulse width modulating section 160, and may further set an allowable range of an error between the specified value and an output value. For example, the test apparatus 100 may set the duty cycle of the pulse to 50%.

The high voltage 130 and the low voltage 140 output predetermined voltages, and the multi-phase pulse width modulating section 160 supplies prescribed pulses to the plurality of the switches in the switch section 150 (S310). Here, the high voltage 130, the low voltage 140 and the multi-phase pulse width modulating section 160 may obey initial values when the initial values are set in the test apparatus 100.

The changing section 170 compares the output voltage to the specified voltage, and when these values are not identical or the error between them exceeds an allowable range, the changing section changes a level of the high voltage 130 (S320). The changing section 170 may lower the level of the high voltage 130 when the output voltage is higher than the specified voltage. On the contrary, the changing section 170 may raise the level of the high voltage 130 when the output voltage is lower than the specified voltage.

When a duty cycle of the pulse output by the multi-phase pulse width modulating section 160 and the output voltage do not correspond with specified values respectively or their errors exceed their allowable ranges, go back to Step S310 and the power supply section 110 adjusts the duty cycle of the pulse (S330). When the duty cycle of the pulse output by the multi-phase pulse width modulating section 160 is set as the specified value or its errors is within the allowable range, the power supply section 110 proceeds to the step S340 without adjusting the duty cycle.

The power supply section 110 repeats the steps S310 and S320 until the output voltage and the duty cycle of the pulse output by the multi-phase pulse width modulating section 160 correspond with the specified values or their errors fall within the allowable ranges. Once the output voltage and the duty cycle of the pulse output by the multi-phase pulse width modulating section 160 become the specified values or their errors fall within the allowable ranges, the test apparatus 100 finishes the control of the voltages and initiates the test of the device under test 10.

According to the test apparatus 100 of the embodiment, the power supply section 110 can cause a duty of the pulse width output by the multi-phase pulse width modulating section 160 to approach a prescribed specified value and can output a voltage as specified. In other words, the test apparatus 100 can supply the device under test 10 with a specified voltage having a low noise level.

In the foregoing description, the example in which the power supply section 110 sets initial values of the high voltage 130 and the low voltage 140, and changes the high voltage 130 depending on the output voltage has been described. Alternatively, the power supply section 110 may fix the low voltage 140 to a ground potential. In this case, it is possible to reduce the number of variable stabilized-power supply units provided in the power supply section 110 to one. Furthermore, the power supply section 110 may change the low voltage 140 depending on the output voltage. In this case, the power supply section 110 may fix the low voltage 140 to the ground potential.

Although the changing section 170 changes the voltage difference between the high voltage 130 and the low voltage 140 depending on the output voltage in the above example, the changing section 170 may alternatively change the voltage between the high voltage 130 and the low voltage 140 depending on a specified voltage. For example, the changing section 170 may set the voltage difference between the high voltage 130 and the low voltage 140 to a value double the value of the specified voltage.

To cause the duty of the pulse width to approach 50% and to output an voltage that corresponds with the specified voltage at the same time, it is anticipated that the power supply section 110 set the voltage difference between the high voltage 130 and the low voltage 140 to a value about twice as high as the specified voltage. The changing section 170 changes the value of the voltage difference between the high voltage 130 and the low voltage 140 to double the specified voltage, and thereby it is possible to reduce the time required for focusing the output voltage to the specified voltage. As a result, the test apparatus 100 can promptly start a test.

Moreover, the test apparatus 100 may set the voltage difference between the high voltage 130 and the low voltage 140 to the value twice as high as the specified voltage, and conduct the control of the multi-phase pulse width modulating section 160 without performing the setting change by the changing section 170. When the voltage between the high voltage 130 and the low voltage 140 is set to double the specified voltage, the multi-phase pulse width modulating section 160 ideally sets the duty cycle of the output pulse to 50% so that the output voltage of the power supply section 110 becomes same as the specified voltage.

However, the power supply section 110 could output a voltage of which level does not correspond with the specified voltage because of losses due to circuits and devices in the power supply section 110, differences from circuit parameters and so forth. In this case, the multi-phase pulse width modulating section 160 shifts the duty cycle of the pulse from 50% by the amount of the error, and the power supply section 110 then can output the voltage that corresponds with the specified voltage. Moreover, because the setting change by the changing section 170 is not performed, the power supply section 110 can shorten the time required for focusing the output voltage to the specified voltage.

The power supply section 110 can set an initial value for the duty cycle of the pulse in the above example, and the power supply section 110 may further set an initial value of the pulse duty to a specified value. In this way, it is possible to reduce the time required for focusing the output voltage to a specified value because the goal for the power supply section 110 is to cause the duty cycle of the pulse to approach the specified value.

In this case, it may not be necessary to control the multi-phase pulse width modulating section 160 for changing the duty cycle of a pulse output therefrom, and the power supply section 110 may adjust the output voltage to the specified value only by performing setting change by the changing section 170. In this way, the power supply section 110 can shorten the time required for focusing the output voltage to a specified voltage.

In the above-described example, the changing section 170 compares an output voltage to a specified voltage and changes the high voltage 130 if the output voltage is not identical to the specified voltage or a difference between them exceeds an allowable range. When the changing section 170 changes the high voltage 130, the changing section 170 may alternatively change the high voltage 130 in response to a change in the output voltage at a speed slower than a response speed of the multi-phase pulse width modulating section 160 responding to the change in the output voltage.

For example, the power supply section 110 causes a duty cycle of a pulse to approach 50%, and at the same time causes the output voltage to approach a specified voltage by adjusting the high voltage 130. When the response speeds of the output voltage with respect to changes in the duty cycle of a pulse and the high voltage 130 are substantially the same, there is a possibility that the power supply section 110 fails to focus the output voltage to the specified voltage.

In order to avoid this, the changing section 170 sets a response speed of the high voltage 130 with respect to change in the output voltage lower than a response speed of the multi-phase pulse width modulating section 160 with respect to the change in the output voltage. In this way, the power supply section 110 will neither diverge nor vibrate but be able to converge the output voltage on the specified voltage.

Although the changing section 170 changes the duty cycle of a pulse and the high voltage 130 according to the output voltage, or changes the high voltage 130 according to a specified voltage, the changing section 170 may switch its operation between the operation according to the output voltage and the operation according to a specified voltage. For example, the changing section 170 may change the high voltage 130 according to the output voltage until the output voltage reaches a specified voltage or falls within a reference range, and may change the high voltage 130 according to the specified voltage once the output voltage reaches the specified voltage or falls in the reference range.

Moreover the changing section 170 may operate according to a specified voltage when the output voltage greatly separates from the specified voltage such as at the time of power activation. As described above, the changing section 170 can shorten the time required for focusing the output voltage to a specified voltage by selecting methods for changing the high voltage 130 according to a difference between the output voltage and the specified voltage.

While the embodiment of the present invention has been described, the technical scope of the invention is not limited to the above described embodiments. It is apparent to persons skilled in the art that various alterations and improvements can be added to the above-described embodiment. It is also apparent from the scope of the claims that embodiments added with such alterations or improvements can be included in the technical scope of the invention.

The operations, procedures, steps, and stages of each process performed by an apparatus, system, program, and method shown in the claims, embodiments, or diagrams can be performed in any order as long as the order is not indicated by “prior to,” “before,” or the like and as long as the output from a previous process is not used in a later process. Even if the process flow is described using phrases such as “first” or “next” in the claims, embodiment, or diagrams, it does not necessarily mean that the process must be performed in this order.

What is claimed is:

1. A power supply that outputs an output voltage corresponding to a specified voltage through an output terminal, comprising:
a plurality of switches that select which of a high voltage and a low voltage is coupled to the output terminal;
a multi-phase pulse width modulating section that controls a pulse width of the high voltage output from each of the plurality of the switches to cause the output voltage to approach the specified voltage; and
a changing section that changes a voltage difference between the high voltage and the low voltage according to the specified voltage or the output voltage.

2. The power supply according to claim 1, wherein,
the multi-phase pulse width modulating section inverts a phase of the high voltage output from at least a pair of the switches with respect to another pair of the switches included in the plurality of the switches, and the changing section changes the voltage difference such that the specified voltage or the output voltage approaches an intermediate voltage between the high voltage and the low voltage.

3. The power supply according to claim 2, wherein the plurality of the switches includes at least a set of the pairs of the switches.

4. The power supply according to claim 2, wherein the changing section changes the voltage difference such that a duty of the pulse width approaches 50%.

5. The power supply according to claim 1, wherein the changing section fixes the low voltage as a ground voltage and changes the high voltage according to the specified voltage or the output voltage.

6. The power supply according to claim 5, wherein the changing section changes the high voltage according to the specified voltage.

7. The power supply according to claim 6, wherein the changing section changes the high voltage to be twice as high as the specified voltage.

8. The power supply according to claim 5, wherein the changing section changes the high voltage according to the output voltage.

9. The power supply according to claim 8, wherein the changing section changes the high voltage to be twice as high as the output voltage.

10. The power supply according to claim 8, wherein the changing section changes the high voltage according to change in the output voltage at a speed lower than a response speed of the multi-phase pulse width modulating section responding to the change in the output voltage.

11. A test apparatus that tests a device under test, comprising:
a power supply section that includes the power supply according to claim 1, the power supply providing power to the device under test; and
a testing section that tests the device under test.

12. A method for controlling a power supply that includes a plurality of switches, which each select a high voltage or a low voltage to be coupled to an output terminal, and outputs an output voltage corresponding to a specified voltage through an output terminal, comprising:
modulating a multi-phase pulse width to control a pulse width of the high voltage output from each of the plurality of the switches to cause the output voltage to approach the specified voltage; and
changing a voltage difference between the high voltage and the low voltage according to the specified voltage or the output voltage.
